(19) United States
(12) Patent Application Publication
(10) Pub. No.: US 2007/0226113 A1
(43) Pub. Date: Sep. 27, 2007

(54) Systems and methods for providing virtual financial markets

(76) Inventor: Craig Johnson, Jersey City, NJ (US)

Correspondence Address: KIRKPATRICK & LOCKHART PRESTON GATES ELLIS LLP, 535 SMITHFIELD STREET, PITTSBURGH, PA, 15222, US

(21) Appl. No.: 11/528,498

(22) Filed: Sep. 27, 2006

Related U.S. Application Data
(60) Provisional application No. 60/720,827, filed on Sep. 27, 2005.

(51) Int. Cl. G06Q 40/00

(52) U.S. Cl. 705/36 R

(57) ABSTRACT

Systems and methods for combining information about financial instruments traded on at least two financial markets to create a virtual market. The method may comprise the steps of (1) determining a common price measure type for instruments traded on two (or more) financial markets; (2) determining a common tick size for instruments traded on the financial markets; (3) determining a price level for an instrument traded on the first market expressed in units of the common price measure type; and (4) determining a price level for an instrument traded on the second markets, also expressed in units of the common price measure type. The method may also comprise displaying the first and second price levels simultaneously in a user display. The method may additionally comprise receiving an order for the first instrument via the user display (such as a buy order or a sell order). The method may also comprise determining and displaying the price levels and quantities of bids and asks on the markets, expressed in terms of the common price measure type and a common quantity measure type.

### CROSS REFERENCE TO RELATED APPLICATIONS

This application claims priority under 35 U.S.C. § 119(e) to U.S. provisional patent application Ser. No. 60/720,827, filed Sep. 27, 2005, entitled “Systems and Methods for Providing Virtual Financial Markets,” listing Craig Johnson as inventor, which is incorporated herein by reference.

### BACKGROUND

In financial markets, traders carry out trades (e.g., buying or selling a security, a derivative contract, etc.). Before carrying out a trade (e.g., buying or, many traders first consider a wide range of information obtained from a variety of sources. For example, a bond trader may consider information from five or six different markets before carrying out a trade. The trader may use different computer-based interfaces to access the information, and the information from each market may be presented on different screens with different layouts. As a result of the complexity associated with accessing all the information and carrying out a trade, many markets do not realize the level of liquidity desired.

### SUMMARY

In one general respect, the present invention is directed to systems and methods for combining information about financial instruments traded on at least two financial markets to create a virtual market. According to various embodiments, the computer-assisted method may comprise the steps of (1) determining a common price measure type for instruments traded on the two (or more) financial markets; (2) determining a common tick size for instruments traded on the financial markets; (3) determining a price level for an instrument traded on the first market expressed in units of the common price measure type; and (4) determining a price level for an instrument traded on the second markets, also expressed in units of the common price measure type. The method may also comprise displaying the first and second price levels simultaneously in a user display. The method may additionally comprise receiving an order for the first instrument via the user display (such as a buy order or a sell order).

The method may also comprise determining and displaying the price levels and quantities of bids and asks on the markets, expressed in terms of the common price measure type and a common quantity measure type. The common tick size may be determined by: (1) determining a first minimum possible change in price measure for instruments traded on one of the two financial markets; (2) converting the first minimum possible change to the common price measure type; (3) determining a second minimum possible change in price measure for instruments traded on the second of the two financial markets; (4) converting the second minimum possible change to the common price measure type; and (5) determining the greatest common divisor of the first and second minimum possible changes after conversion to the common price measure type. According to various implementations, the markets may be actual and/or virtual markets.

Other aspects of the present invention are directed to related computer systems and computer readable media.

### DESCRIPTION OF THE DRAWINGS

Various embodiments of the present invention are described herein by way of example in conjunction with the following figures, wherein:

FIG. 1 illustrates various embodiments of a system for providing a virtual financial market;

FIGS. 2-6 illustrate various examples of information presented on a single display screen;

FIG. 7 illustrates various embodiments of a method for providing a virtual financial market;

FIG. 8 is a diagram of a process flow for pricing integration module of the system of FIG. 1 according to various embodiments of the present invention; and

FIG. 9 is a diagram of a process for determining the common tick size according to various embodiments of the present invention.

### DETAILED DESCRIPTION

The figures and descriptions of the disclosed invention have been simplified to illustrate elements that are relevant for a clear understanding of the disclosed invention. It should be understood that the methods, products, and systems described below may include various other processes, components, and elements in actual implementation.

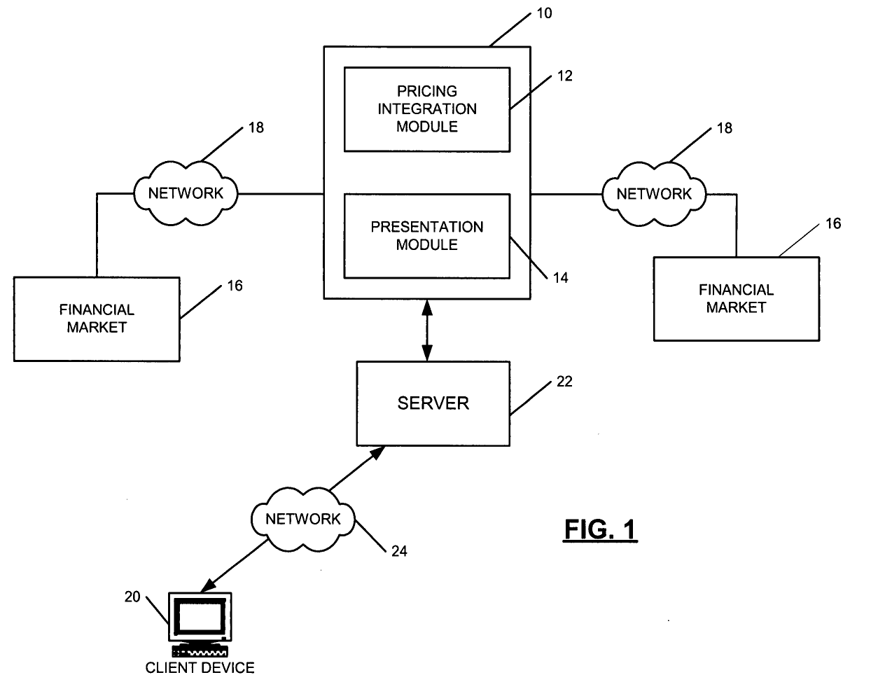

FIG. 1 illustrates various embodiments of a computer-based system 10 for providing a virtual market. The system 10 includes a pricing integration module 12 and a presentation module 14. The system 10 may be in communication with data feeds for any number of financial markets 16 via any number of electronic communications networks 18. The computer-based system 10 may comprise one or more networked computer devices, each comprising at least one processor. The computer device(s) may be, for example, a server, a PC, a workstation, a mainframe, etc.

In general, the system 10 may be connected to the data feeds from various financial markets 16 and the electronic communications networks 18 via wired or wireless data pathways. The electronic communications networks 18 may include any type of delivery system including, but not limited to, a local area network (e.g., Ethernet), a wide area network (e.g., the Internet and/or World Wide Web), a telephone network (e.g., analog, digital, wired, wireless, PSTN, ISDN, GSM, GPRS, and/or xDSL), a packet-switched network, a radio network, a television network, a cable network, a satellite network, and/or any other wired or wireless communications network configured to carry data. The electronic communications networks 18 may include elements such as, for example, intermediate nodes, proxy servers, routers, switches, and adapters configured to direct and/or deliver data.

In general, the system 10 may be structured and arranged to communicate with the financial markets 16 via the electronic communications networks 18 using various communication protocols (e.g., HTTP, TCP/IP, UDP, WAP, WiFi, Bluetooth) and/or to operate within or in concert with one or more other communications systems.

The pricing integration module 12 is configured for integrating pricing information from the various financial markets 16. The pricing integration module 12 may combine instruments trading on different actual markets to create a virtual market comprising financial products formed by the combination of the instruments from the various financial markets 16. The resulting financial products may be further combined to create additional virtual markets.

Each market, virtual or actual, may be defined to be the aggregate of an instrument component and a depth component. For a given market, the instrument component may be defined according to a price measure type, a quantity measure type, and a tick size. The depth component may be defined according to a set of price levels for the bid side of the market ordered from best price to worst price, and a set of price levels for the ask side of the market ordered from best price to worst price.

For the price measure type, possible values include values associated with the yield of the instrument, the price of the instrument, the 100-yield of the instrument, or the yield change on day of the instrument. For the quantity measure type, possible values include par/contracts values and DV01 values of the instrument. The tick size refers to smallest possible up or down change in the value of the price measure type. According to various embodiments, the values associated with the instrument component are static—they do not change once they are defined.

With respect to the depth component, a price level comprises a price measure and a quantity measure. The price measure may be expressed in units of price measure type. The quantity measure may be expressed in units of quantity measure type. The quantity measure may define a participation list, and the participation list may include a list of trader names and/or trader sizes. According to various embodiments, the value of the depth component may change in real-time.

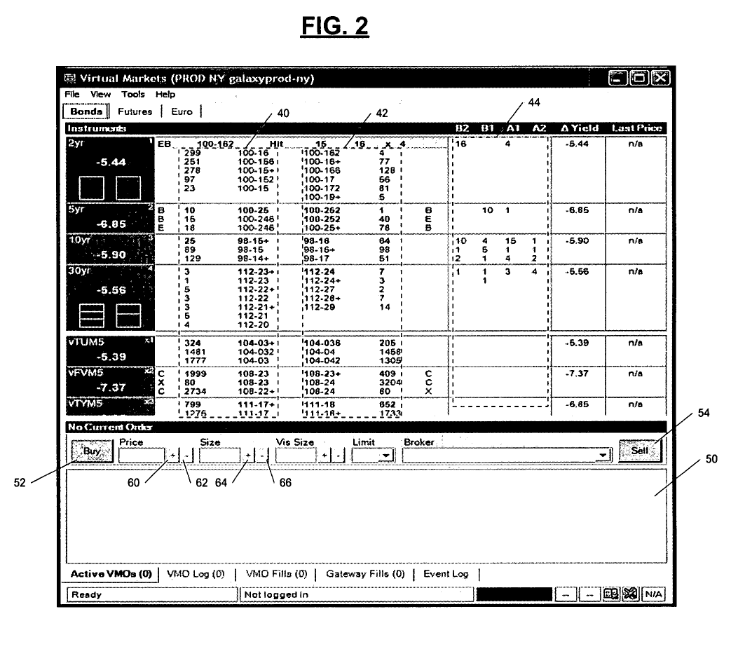

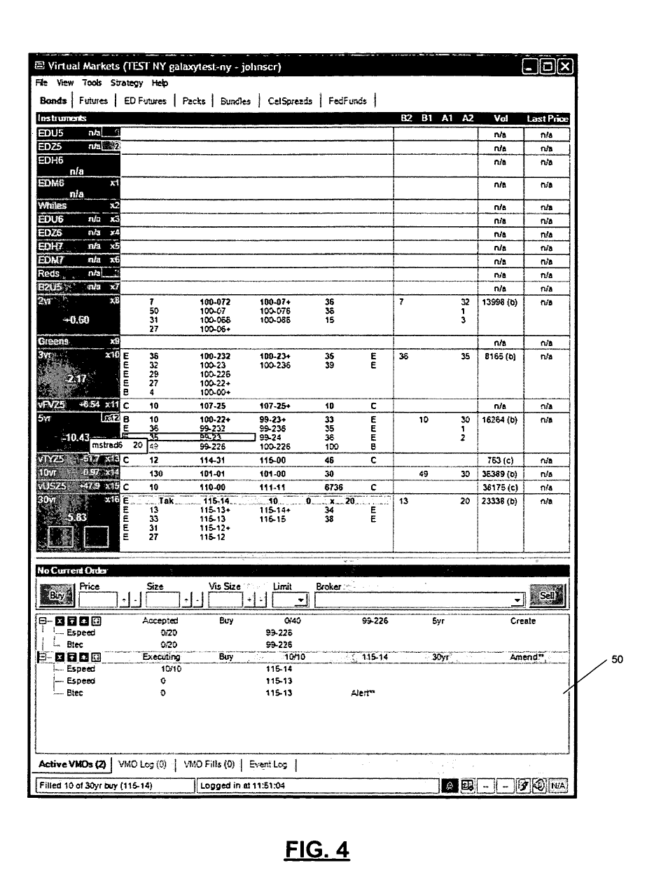

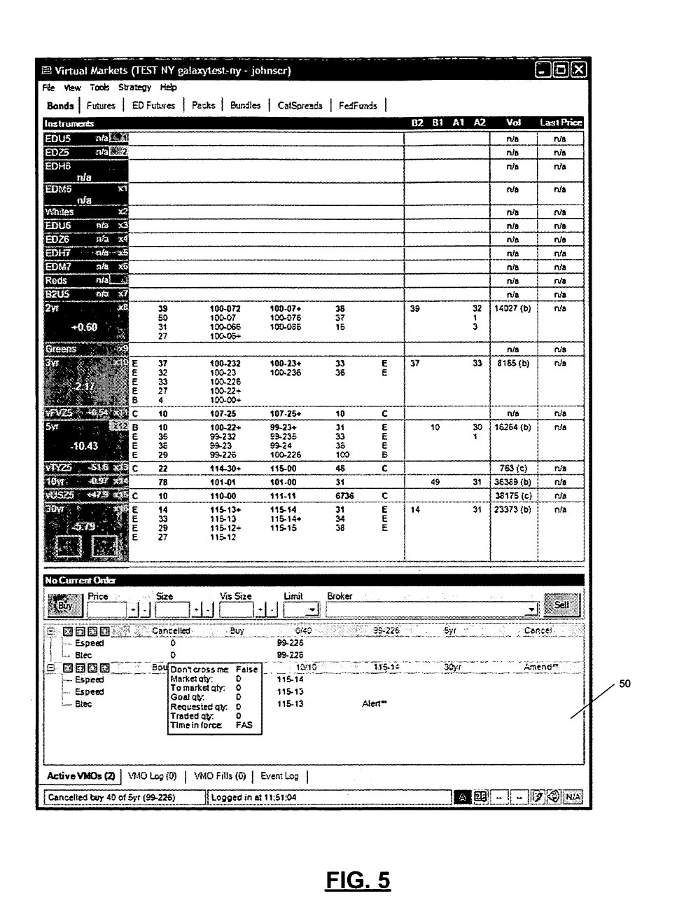

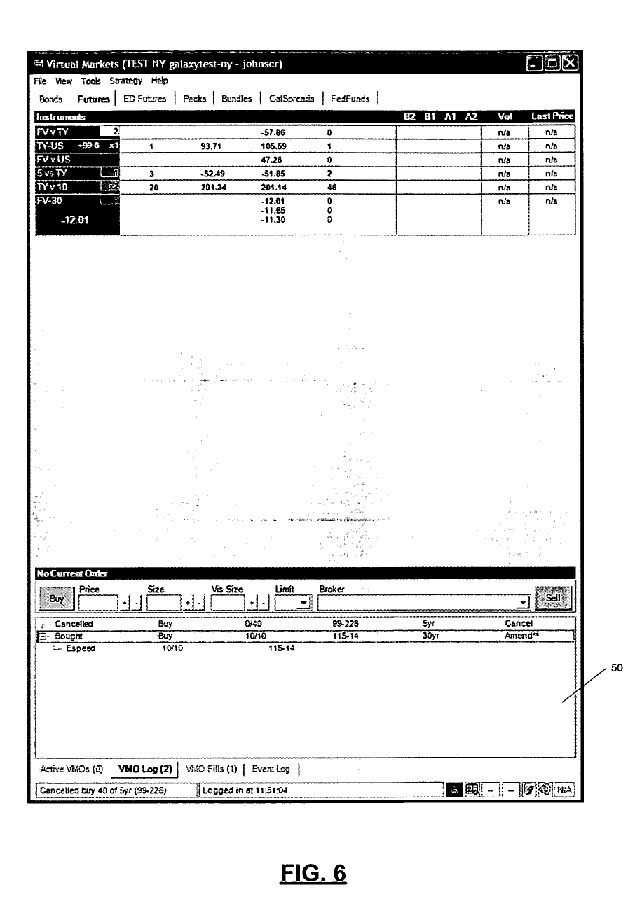

The presentation module 14 is configured for presenting the integrated pricing information in a display to an end-user in a convenient format. For example, the presentation module 14 may present multiple virtual markets for a variety of financial products on a single user display screen. The displays may be served to the end-user at a client device 20 via a server 22 and a communications network 24. The presentation module 14 may be further configured for presenting updated integrated pricing information in real-time. The integrated pricing information for the various financial products may be presented to the user as if it comprised a portion of a true financial market. FIGS. 2-6 illustrate various examples of information that may be presented on a single user display.

According to various embodiments, the market pricing information display may be customizable by a user of the system 10. For example, the display may be customized to only display a certain number of rows in market depth, and may be customized such that the components which comprise the integrated pricing information may be viewed independently.

The presentation module 14 may present detailed participation data to provide insight into the internal structure of a given market. For example, the total available size for each bid and ask may be displayed adjacent to the corresponding bid and ask price, as shown in columns 40 (bids) and 42 (asks), respectively, in FIG. 2. A detailed breakdown of the best bid and ask sizes for each market participant may be displayed in a separate column (column 44). In addition, a graphical representation of the participation breakdown may be displayed. Furthermore, all participations corresponding to orders from a current user may be indicated by displaying the number in a special color, and all participations corresponding to orders from a firm may be indicated by displaying the number in a different special color.

According to various embodiments, bid and ask data for actual and virtual markets may be arranged to maximize a user's ability to assimilate and act on market prices. For example, the best bid and best ask prices (inside market) may be displayed at the top of a stack, and may be displayed in a larger typeface (see columns 40, 42 of FIG. 2). Also, bid and ask columns may be placed adjacent to one another for easy comparison. In addition, the condition of a component market being in workup status may be indicated by the corresponding depth line being highlighted.

The modules 12, 14 may be implemented as code to be executed by a processor(s) (not shown) of the computer-based system 10 utilizing any suitable computer language (e.g., C, C++, Java, JavaScript, Visual Basic, VBScript, Delphi) and may be embodied permanently or temporarily in any type of machine, component, physical or virtual equipment, storage medium, or propagated signal capable of delivering instructions to a device. The modules 12, 14 (e.g., software application, computer program) may be stored on a computer-readable medium (e.g., disk, device, and/or propagated signal) such that when the processor(s) reads the medium, the functions described herein are performed.

The system 10 may be utilized to allow users to combine financial products from other actual and virtual markets in various ways to create virtual markets for new, custom financial products. Such financial products may be comprised of several exchange traded instruments such as, for example, treasury securities and futures thereof, LIBOR futures, etc. The system 10 may also be utilized to allow the user to execute an order on any presented virtual market as if the virtual market were an actual market. The system 10 may further be utilized to manage orders, within specified parameters, so as to optimize the execution price.

According to various embodiments, orders can be executed directly from a market information screen. The orders may be created by simply clicking a mouse on the depth for a desired instrument. A created order may be displayed in a current order section 50 of the display screen (see FIGS. 2-6) and may be modified before sending. Orders may be modified, for example, for limit price, size, visible size in market, whether or not the order is a limit order, a parameter set to use for order, a broker executing the trade, or an account number.

A bid price or ask price may be entered depending on the side of the depth where the mouse click took place. For example, a click in the left half of a box may enter a bid price, and a click in the right half of a box may enter an ask price. Alternatively, the price corresponding to the row of the depth on which the user clicked may determine the price. According to various embodiments, a rectangle may be displayed around a price to indicate which price will be entered upon clicking the mouse.

Once an order is created, it may be sent to a market. For example, an order on a current order screen may be sent to a market by clicking a buy button 52 or a sell button 54 for the appropriate side of the order.

According to various embodiments, orders may also be modified while in progress. For example, orders that are active in a virtual market may be modified by, for example, adjusting the price up or down by a number of market ticks using price adjustment buttons 60, 62, adjusting the price to the best price on the same side of the market, adjusting the price to the best price on the other side of the market, canceling an unexpected portion of the order, modifying the size of the order using size adjustment buttons 64, 66, forcing different components of an order to synchronize to an appropriate point before continuing execution, adjusting trading strategy parameters, and adjusting various risk limits.

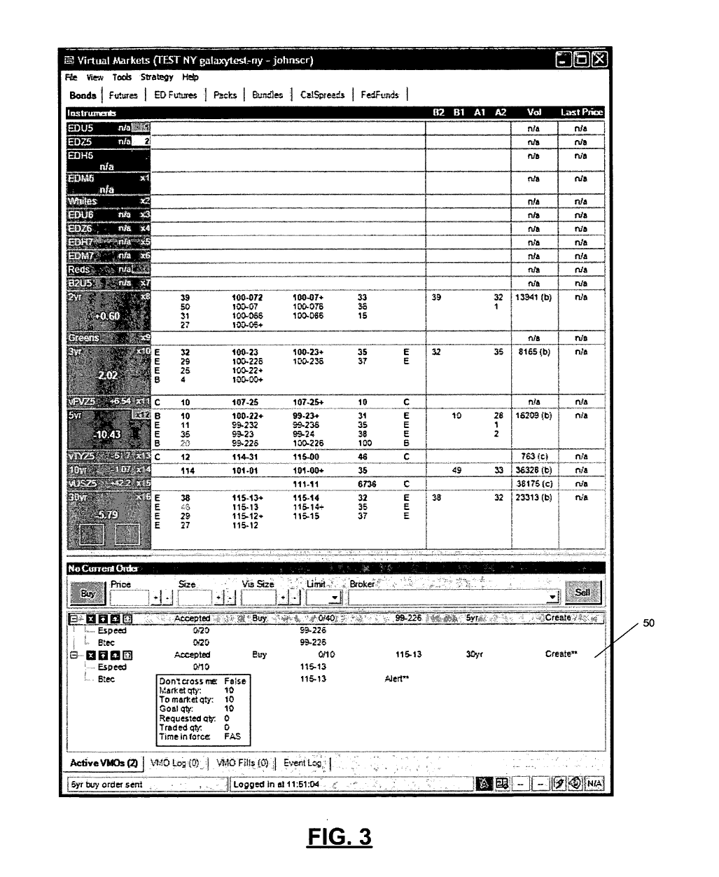

The order status may be displayed and updated in real-time. The order status information displayed may include, for example, the quantity sent to and executed on each component market, and the current target price on each component market (see FIG. 3). According to various embodiments, active orders may be duplicated via a right mouse click, and orders may be created and sent from a custom keyboard.

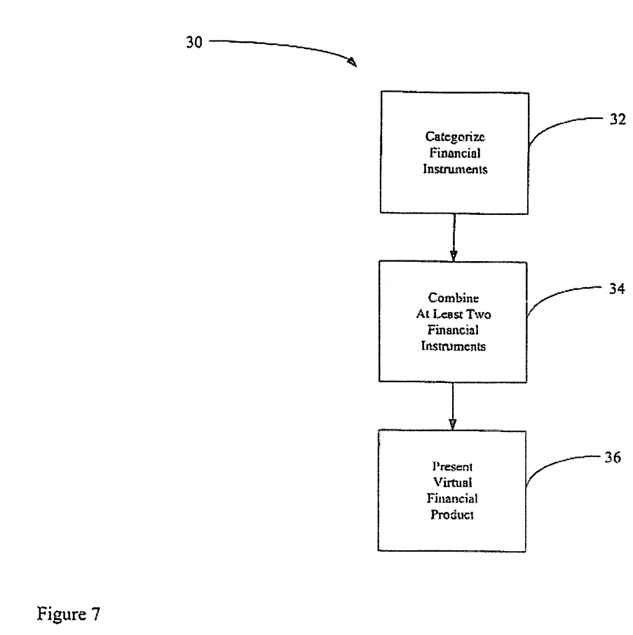

FIG. 7 illustrates various embodiments of a method 30 for providing a virtual financial market. The method 30 includes categorizing financial instruments by price measure type and quantity measure type (block 32), combining at least two financial instruments having both a common price measure type and a common quantity measure type to create a virtual financial product (block 34), and presenting the virtual financial product to a user (block 36). The financial instruments may be associated with a virtual market or an actual market. According to various embodiments, the tick size associated with the resulting financial product may be the greatest common divisor of the tick size of the two component markets after each component tick size has been converted to the common price measure type. The above-described process may be carried out for each side of the market.

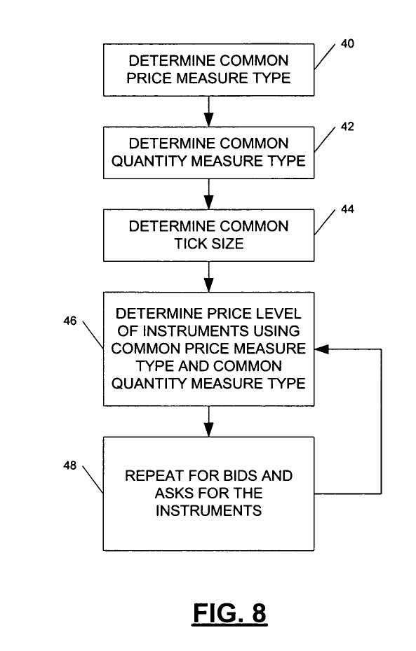

FIG. 8 is a more detailed diagram of the process flow of the pricing integration module 12 according to various embodiments of the present invention. At block 40, for each market (whether actual or virtual), the pricing integration module 12 may determine a common price measure type for instruments traded on those markets. The common price measure type is preferably compatible with the price measures used in the markets themselves. As mentioned before, depending on the instruments, the common price measure type may be expressed in terms of, for example, yield, price, 100-yield, or yield change on day. At block 42, the pricing integration module 12 may determine a common quantity measure type for instruments traded on the markets. Again, the common quantity measure type is preferably compatible with the quantity measure types used for the markets. Depending on the type of instruments, the common quantity measure type may be expressed in terms of par/contracts or DV01, for example. The term “DV01” is commonly understood in the financial industry as meaning the change in the dollar value of a bond or other type of fixed income instrument when its yield falls one basis point.

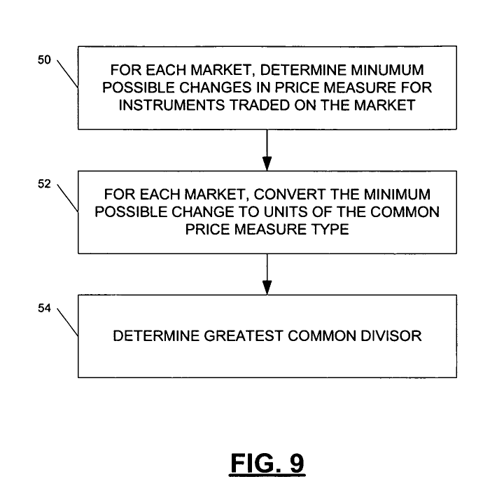

At block 44, the pricing integration module 12 may determine the common tick size. FIG. 9 is a flow chart of a process for determining the common tick size according to various embodiments of the present invention. As shown in FIG. 9, at step 50, for each market from which instruments are being combined to generate the virtual market, the minimum possible change in the price measure for instruments traded in the market is determined. For example, where the price measure is dollars, the minimum possible change may be one cent. Where the price measure is percentage yield, the minimum possible change may be a basis point. Next, at step 52, the minimum possible change for each market is converted to the units of the common price measure type (see block 40 of FIG. 8). Next, at block 54, the greatest common divisor of the minimum possible changes is determined. This value may be used as the common tick size.

Returning to FIG. 8, at block 46, the price level for each instrument in the new market is determined expressed, for example, in units of the common price measure type for one unit of the common quantity measure type. In addition, as shown at block 48, the price levels for each bid and ask for the instruments may be determined. These determined values (e.g., the price levels, the bid price levels, and the ask price levels) may be simultaneously displayed to an end user as shown in the exemplary user displays of FIGS. 2-6.

The benefits of the disclosed methods, systems and computer-readable media are readily apparent to those skilled in the art. The term “computer-readable medium” as used herein may include, for example, magnetic and optical memory devices such as diskettes, compact discs of both read-only and writeable varieties, optical disk drives, and hard disk drives.

A computer-readable medium may also include memory storage that can be physical, virtual, permanent, temporary, semi-permanent and/or semi-temporary. A computer-readable medium may further include one or more data signals transmitted on one or more carrier waves. The various portions and components of various embodiments of the disclosed invention can be implemented in computer software code using, for example, Visual Basic, C, or C++ computer languages using, for example, object-oriented techniques.

While several embodiments of the invention have been described, it should be apparent, however, that various modifications, alterations and adaptations to those embodiments may occur to persons skilled in the art with the attainment of some or all of the advantages of the disclosed invention. For example, various steps in the processes described above may be performed in different orders or simultaneously. Therefore, this application is intended to cover all such modifications, alterations and adaptations without departing from the scope and spirit of the disclosed invention as defined by the appended claims.

What is claimed is:

1. A computer-assisted method for combining information about financial instruments traded on at least two financial markets to create a virtual market comprising:
determining a common price measure type for instruments traded on the at least two financial markets;
determining a common tick size for instruments traded on the at least two financial markets;
determining a first price level for a first instrument traded on a first of the at least two financial markets, wherein the first price level comprises a price measure for the first instrument expressed in units of the common price measure type;
determining a second price level for a second instrument traded on a second of the at least two financial markets, wherein the second price level comprises a price measure for the second instrument expressed in units of the common price measure type; and
displaying the first and second price levels simultaneously in a user display.

2. The method of claim 1, further comprising receiving an order for the first instrument via the user display.

3. The method of claim 1, further comprising:
determining a common quantity measure type for instruments traded on the at least two financial markets;
determining a first bid price level for the first instrument based on a first bid for the first instrument at the first market, wherein the first bid price level comprises a bid price measure for the first instrument expressed in units of the common price measure type and a bid quantity of the first instrument expressed in units of the common quantity measure type; and
determining a first ask price level for the first instrument based on a first ask for the first instrument at the first market, wherein the first ask price level comprises an ask price measure for the first instrument expressed in units of the common price measure type and an ask quantity of the first instrument expressed in units of the common quantity measure type.

4. The method of claim 3, further comprising displaying the first bid price level and the first ask price level simultaneously in the user display.

5. The method of claim 4, further comprising:
determining a second bid price level for the first instrument based on a second bid for the first instrument at the first market, wherein the second bid price level comprises a bid price measure for the first instrument expressed in units of the common price measure type and a bid quantity of the first instrument expressed in units of the common quantity measure type; and
displaying the second bid price level simultaneously in the user display.

6. The method of claim 5, further comprising:
determining a second ask price level for the first instrument based on a second ask for the first instrument at the first market, wherein the second ask price level comprises an ask price measure for the first instrument expressed in units of the common price measure type and a quantity of the first instrument expressed in units of the common quantity measure type; and
displaying the second ask price level simultaneously in the user display.

7. The method of claim 1, wherein determining the common tick size comprises:
determining a first minimum possible change in price measure for instruments traded on the first of the at least two financial markets;
converting the first minimum possible change to the common price measure type;
determining a second minimum possible change in price measure for instruments traded on the second of the at least two financial markets;
converting the second minimum possible change to the common price measure type; and
determining the greatest common divisor of the first and second minimum possible changes after conversion to the common price measure type.

8. The method of claim 7, wherein the first and second markets are actual markets.

9. The method of claim 7, wherein the first market is a virtual market.

10. The method of claim 7, further comprising receiving an order for the first instrument via the user display.

11. A system for combining information about financial instruments traded on at least two financial markets to create a virtual market comprising:
a pricing integration module in communication with data feeds for the at least two financials markets for:
determining a common price measure type for instruments traded on the at least two financial markets;
determining a common tick size for instruments traded on the at least two financial markets;
determining a first price level for a first instrument traded on a first of the at least two financial markets, wherein the first price level comprises a price measure for the first instrument expressed in units of the common price measure type; and
determining a second price level for a second instrument traded on a second of the at least two financial markets, wherein the second price level comprises a price measure for the second instrument expressed in units of the common price measure type; and
a presentation module for displaying the first and second price levels simultaneously in a user display.

12. The system of claim 11, wherein the pricing integration module is for:
determining a common quantity measure type for instruments traded on the at least two financial markets;
determining a first bid price level for the first instrument based on a first bid for the first instrument at the first market, wherein the first bid price level comprises a bid price measure for the first instrument expressed in units of the common price measure type and a bid quantity of the first instrument expressed in units of the common quantity measure type; and
determining a first ask price level for the first instrument based on a first ask for the first instrument at the first market, wherein the first ask price level comprises an ask price measure for the first instrument expressed in units of the common price measure type and an ask quantity of the first instrument expressed in units of the common quantity measure type.

13. The system of claim 12, wherein the presentation module is for displaying the first bid price level and the first ask price level simultaneously in the user display.

14. The system of claim 13, wherein:
the pricing integration module is for determining a second bid price level for the first instrument based on a second bid for the first instrument at the first market, wherein the second bid price level comprises a bid price measure for the first instrument expressed in units of the common price measure type and a bid quantity of the first instrument expressed in units of the common quantity measure type; and
the presentation module is for displaying the second bid price level simultaneously in the user display.

15. The system of claim 14, wherein:
the pricing integration module is for determining a second ask price level for the first instrument based on a second ask for the first instrument at the first market, wherein the second ask price level comprises an ask price measure for the first instrument expressed in units of the common price measure type and a quantity of the first instrument expressed in units of the common quantity measure type; and
the presentation module is for displaying the second ask price level simultaneously in the user display.

16. The system of claim 11, wherein the pricing integration module is for determining the common tick size by:
determining a first minimum possible change in price measure for instruments traded on the first of the at least two financial markets;
converting the first minimum possible change to the common price measure type;
determining a second minimum possible change in price measure for instruments traded on the second of the at least two financial markets;
converting the second minimum possible change to the common price measure type; and
determining the greatest common divisor of the first and second minimum possible changes after conversion to the common price measure type.

17. A system for combining information about financial instruments traded on at least two financial markets to create a virtual market comprising a processor programmed to:
determine a common price measure type for instruments traded on the at least two financial markets;
determine a common tick size for instruments traded on the at least two financial markets;
determine a first price level for a first instrument traded on a first of the at least two financial markets, wherein the first price level comprises a price measure for the first instrument expressed in units of the common price measure type;
determine a second price level for a second instrument traded on a second of the at least two financial markets, wherein the second price level comprises a price measure for the second instrument expressed in units of the common price measure type; and
display the first and second price levels simultaneously in a user display.

18. The system of claim 17, wherein the processor is programmed to receive an order for the first instrument via the user display.

19. The system of claim 17, wherein the processor is programmed to:
determine a common quantity measure type for instruments traded on the at least two financial markets;
determine a first bid price level for the first instrument based on a first bid for the first instrument at the first market, wherein the first bid price level comprises a bid price measure for the first instrument expressed in units of the common price measure type and a bid quantity of the first instrument expressed in units of the common quantity measure type; and
determine a first ask price level for the first instrument based on a first ask for the first instrument at the first market, wherein the first ask price level comprises an ask price measure for the first instrument expressed in units of the common price measure type and an ask quantity of the first instrument expressed in units of the common quantity measure type.

20. The system of claim 19, wherein the processor is programmed to display the first bid price level and the first ask price level simultaneously in the user display.

21. The system of claim 20, wherein the processor is programmed to:
determine a second bid price level for the first instrument based on a second bid for the first instrument at the first market, wherein the second bid price level comprises a bid price measure for the first instrument expressed in units of the common price measure type and a bid quantity of the first instrument expressed in units of the common quantity measure type; and
display the second bid price level simultaneously in the user display.

22. The system of claim 21, wherein the processor is programmed to:
determine a second ask price level for the first instrument based on a second ask for the first instrument at the first market, wherein the second ask price level comprises an ask price measure for the first instrument expressed in units of the common price measure type and a quantity of the first instrument expressed in units of the common quantity measure type; and
display the second ask price level simultaneously in the user display.

23. The system of claim 17, wherein the processor is programmed to determine the common tick size by:
determining a first minimum possible change in price measure for instruments traded on the first of the at least two financial markets;
converting the first minimum possible change to the common price measure type;
determining a second minimum possible change in price measure for instruments traded on the second of the at least two financial markets;
converting the second minimum possible change to the common price measure type; and
determining the greatest common divisor of the first and second minimum possible changes after conversion to the common price measure type.

24. The system of claim 23, wherein the processor is programmed to receive an order for the first instrument via the user display.

25. A computer readable medium having instructions stored thereon which when executed by a processor cause the processor to:
determine a common price measure type for instruments traded on at least two financial markets;
determine a common tick size for instruments traded on the at least two financial markets;
determine a first price level for a first instrument traded on a first of the at least two financial markets, wherein the first price level comprises a price measure for the first instrument expressed in units of the common price measure type;
determine a second price level for a second instrument traded on a second of the at least two financial markets, wherein the second price level comprises a price measure for the second instrument expressed in units of the common price measure type; and
display the first and second price levels simultaneously in a user display.

26. The computer readable medium of claim 25, having stored thereon instructions which when executed by the processor cause the processor to place an order for the first instrument based on an input received via the user display.

27. The computer readable medium of claim 25, having stored thereon instructions which when executed by the processor cause the processor to:
determine a common quantity measure type for instruments traded on the at least two financial markets;
determine a first bid price level for the first instrument based on a first bid for the first instrument at the first market, wherein the first bid price level comprises a bid price measure for the first instrument expressed in units of the common price measure type and a bid quantity of the first instrument expressed in units of the common quantity measure type; and
determine a first ask price level for the first instrument based on a first ask for the first instrument at the first market, wherein the first ask price level comprises an ask price measure for the first instrument expressed in units of the common price measure type and an ask quantity of the first instrument expressed in units of the common quantity measure type.

28. The computer readable medium of claim 27, having stored thereon instructions which when executed by the processor cause the processor to display the first bid price level and the first ask price level simultaneously in the user display.

29. The computer readable medium of claim 28, having stored thereon instructions which when executed by the processor cause the processor to:
determine a second bid price level for the first instrument based on a second bid for the first instrument at the first market, wherein the second bid price level comprises a bid price measure for the first instrument expressed in units of the common price measure type and a bid quantity of the first instrument expressed in units of the common quantity measure type; and
display the second bid price level simultaneously in the user display.

30. The computer readable medium of claim 29, having stored thereon instructions which when executed by the processor cause the processor to:
determine a second ask price level for the first instrument based on a second ask for the first instrument at the first market, wherein the second ask price level comprises an ask price measure for the first instrument expressed in units of the common price measure type and a quantity of the first instrument expressed in units of the common quantity measure type; and
display the second ask price level simultaneously in the user display.

31. The computer readable medium of claim 25, having stored thereon instructions which when executed by the processor cause the processor to determine the common tick size by:
determining a first minimum possible change in price measure for instruments traded on the first of the at least two financial markets;
converting the first minimum possible change to the common price measure type;
determining a second minimum possible change in price measure for instruments traded on the second of the at least two financial markets;
converting the second minimum possible change to the common price measure type; and
determining the greatest common divisor of the first and second minimum possible changes after conversion to the common price measure type.
